(19) United States
(12) Patent Application Publication
(10) Pub. No.: US 2011/0222753 A1
(43) Pub. Date: Sep. 15, 2011

(54) Adjusting Radiological Images

(75) Inventors: Jeffrey J. Kotula, Eden Prairie, MN (US); Sarah Osmundson, St. Louis Park, MN (US); Wade J. Steigauf, Bloomington, MN (US)

(73) Assignee: VIRTUAL RADIOLOGIC CORPORATION, Minneapolis, MN (US)

(21) Appl. No.: 12/722,277

(22) Filed: Mar. 11, 2010

(51) Int. Cl. G06K 9/00

(52) U.S. Cl. 382/132

(57) ABSTRACT

In one embodiment, an image processing system can be configured to generate and adjust a radiological image. Upon receiving input via a user interface control indicating a specified adjustment in slab thickness of the radiological image, and upon receiving input via a user interface control indicating a specified reconstruction technique, the image processing system can generate an adjusted radiological image based on the received input, and can present the image on a display.

### BACKGROUND

Medical images, such as X-rays, CAT (computerized axial tomography) scans, and MRI's (Magnetic Resonance Imaging), may be digitized to facilitate remote reading by radiologists. A hospital or other medical facility may use machines that capture and digitize the images and transmit them to a remote image server, such as a Picture Archiving and Communications System (PACS). The transmission may occur over a network, such as an intranet or the Internet.

Additionally, the hospital may also transmit orders corresponding to the images to an order server, such as a Radiologist Information System (RIS). The orders may be requests for a radiologist to interpret, or read, the images and return a diagnostic report. Orders may also contain information, such as a patient identifier, the procedure type associated with the image, patient demographic information, and a hospital identifier.

Both the images and orders may be transmitted by the image server and the order server, respectively, to a remote system operated by a radiologist. After receipt of the images and orders, the radiologist may analyze the image and return the diagnostic report using the remote system. The diagnostic report may be transmitted through the network to the order server, which may send the report to the hospital or other medical facility that originally transmitted the order and images corresponding to the report.

### SUMMARY

In one embodiment, an image processing system can be configured to generate and adjust a radiological image. Upon receiving input via a user interface control indicating a specified adjustment in slab thickness of the radiological image, and upon receiving input via a user interface control indicating a specified reconstruction technique, the image processing system can generate an adjusted radiological image based on the received input, and can present the image on a display.

In some implementations, the image processing system may include an imaging device for capturing image data, an image formatter for rendering the radiological image based on captured image data and based on one or more presentation parameters, and an image viewer for receiving and displaying the radiological image. The image processing system may also include one or more input devices for specifying an adjustment in slab thickness of the radiological image and for specifying a reconstruction technique. Using the input devices, a user of the image processing system may interact with controls included in a graphical user interface to specify adjustments and reconstruction techniques for the radiological image.

In some implementations, the specified adjustment in slab thickness may be a distance, a percentage, or a number of images to combine. In some implementations, the specified reconstruction technique may be maximum-intensity projection, minimum-intensity projection, or a color averaging technique. In some implementations, the adjusted radiological image may be generated dynamically.

### DESCRIPTION OF DRAWINGS

FIG. 1 shows an example teleradiology system.

FIG. 2 is a block diagram of an example teleradiology system.

FIG. 3 is a block diagram of an example process for generating one or more images for presentation.

FIG. 4 is a flow chart showing an example process for displaying and adjusting images.

FIG. 5 is an illustration of an example interface for presenting and adjusting radiological images.

FIG. 6 is a block diagram of a generic computing system that can be used in connection with computer-implemented methods described in this document.

### DETAILED DESCRIPTION

Illustrative implementations of computer-based systems, methods, and interfaces for generating, displaying, and adjusting radiological images are described. The described systems, methods, and interfaces can enable a radiologist in a teleradiology environment to view, interact with, and analyze images, and to provide diagnostic findings to a medical facility.

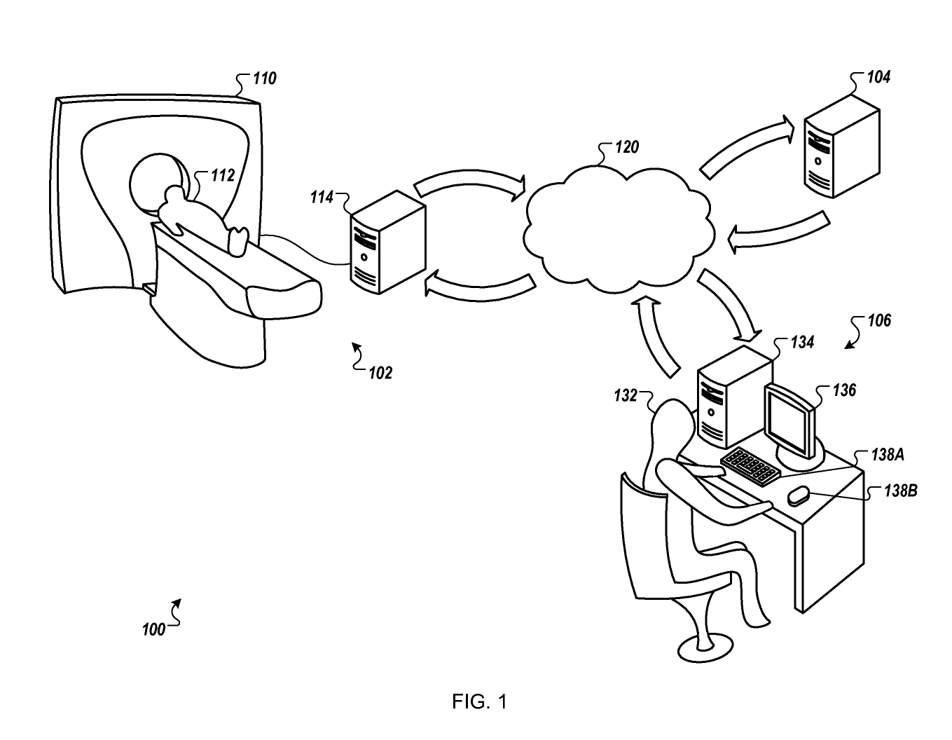

Referring to FIG. 1, an example teleradiology system 100 is shown. The system 100 can be used for capturing medical image data in one location and for reviewing medical images associated with the data in another location. The system 100 can include many geographically separated imaging devices and many image review terminals. For purposes of illustration, the teleradiology system 100 shown in FIG. 1 includes an imaging system 102, an image order (IO) management system 104, and an image review system 106. The imaging system 102, for example, may include an imaging device 110, such as a CT (computer tomography) scanner or an MRI (magnetic resonance imaging) scanner. Using an energy source such as x-rays or magnetic fields, for example, the imaging device 110 may capture image data associated with a subject 112 (e.g., a patient). In some implementations, the image data may include a series of two-dimensional images. In some implementations, the image data may be used to produce a three-dimensional model that can be further manipulated and reformatted for generating two-dimensional (or three-dimensional) images. Image data captured by the imaging device 110 can be stored and processed by an imaging device server 114 (e.g., one or more computers with a processor and a memory) and can be provided to other systems and computers in the system 100 through a network 120 (e.g. an intranet or the Internet).

In some implementations, image data may be provided to the IO management system 104, where the data may be stored and processed by one or more computers. For example, the IO management system 104 may determine that the image data is to be provided to a system user 132 (e.g., a radiologist) at the image review system 106. As shown, image data can be provided by the IO management system 104 to the image review system 106 through the network 120.

The image review system 106, for example, may include an image display server 134 (e.g., one or more computers with a processor and a memory), a display device 136 (e.g., a monitor), and input devices 138A-B (e.g., keyboards, computer mice, joysticks, touch interfaces, voice interfaces, and the like). In some implementations, image data may be processed by the image display server 134 and visually presented to the user 132 as one or more images at the display device 136. Using the input devices 138A-B, the user 132 may interact with the presented images, for example, by manipulating one or more user controls included in a graphical user interface presented at the display device 136 in association with the images. For example, the user 132 may view an image (or a series of related images), and may specify one or more image adjustments, such as zooming, panning, rotating, changing contrast, changing color, changing view angle, changing view depth, changing rendering or reconstruction technique, and the like. By viewing and interacting with presented image data and with the user interface, for example, the user 132 may produce and indicate a diagnostic finding related to the subject 112.

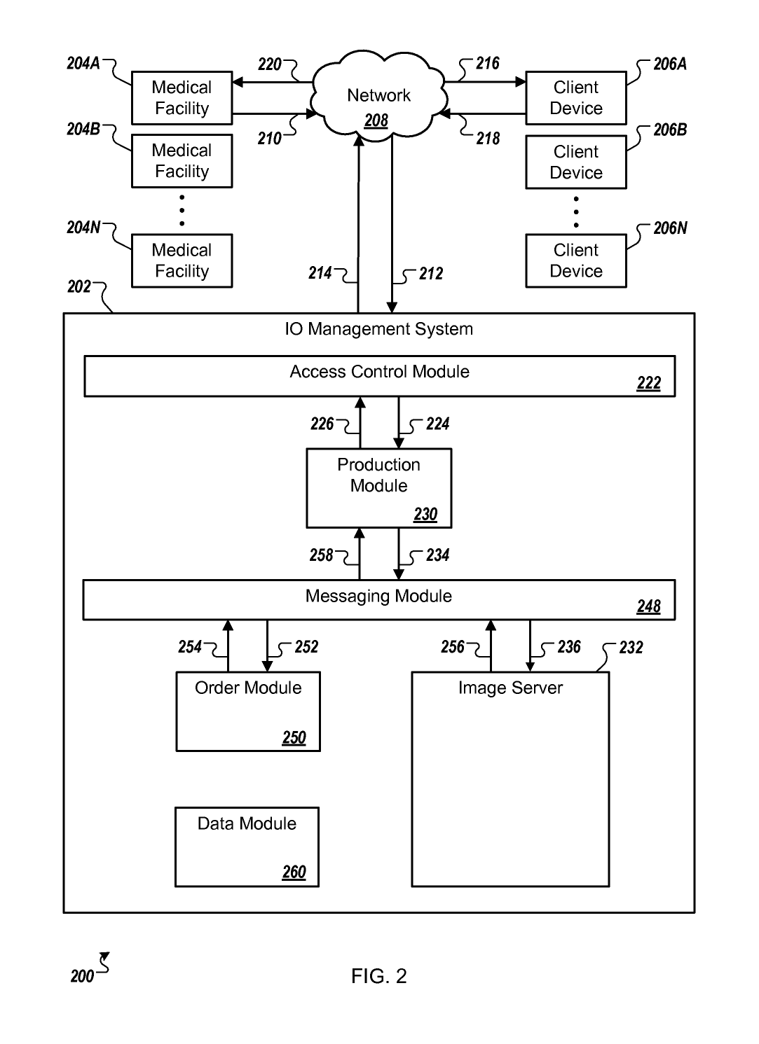

FIG. 2 shows an example of a teleradiology system 200 including an image order management system 202, medical facilities 204, and client devices 206 connected by a network 208, such as the Internet. The medical facilities 204 may send images and orders for studying the images to the IO management system 202, as represented by arrows 210 and 212. The images may include representations of body parts such as x-rays, CAT scans, and MRIs. The images may also contain information, such as which medical facility sent the image, the number of images in the transmission, the patient name, and other patient demographic information. The orders may contain information about a patient, such as name, medical history, and the reason the image was taken. The order may also include a description of an associated image, such as a pelvic abdominal scan, a number of images associated with the order, and an order type, such as preliminary or final read. The presence of the patient name and other patient information may enable a particular image to be linked with a particular order. The IO management system 202 may store the images and orders and assign the orders to appropriate users at the client devices 206. For example, the IO management system 202 may assign an order from a medical facility 204A to a radiologist at a client device 206A. If the radiologist accepts the order, the IO management system 202 may make the images associated with the order available to the radiologist for viewing, as indicated by arrows 214 and 216. The radiologist can interpret the images and send a report back to the IO management system 202, as represented by arrows 218 and 212. The IO management system 202 may then forward the report to the originating medical facility, as indicated by arrows 214 and 220, where the report may be used in a diagnosis for the patient.

The IO management system 202 may be implemented on a single computing device or on multiple computing devices, such as a server farm. In some implementations, the IO management system 202 may be disbursed over several servers that are connected through a network. This configuration may enable expansion of the system and flexibility in managing the flow of received and output images and orders.

Medical facilities may send images and orders at the same time as one another or at different times. Images, orders, and reports may be sent over the same network or different networks. For example, the IO management system 202 may receive images and orders through a single T1 connection to the Internet, or the images may be received from the Internet through a T1 connection and the orders may be received through a modem connection. As another example, the IO management system 202 may receive an image and an order from a medical facility over the Internet and return a corresponding report to the medical facility over a fax connection.

Additionally, the images and orders may be sent separately or combined in one transmission. For instance, a computing device at a medical facility may use software that sends the orders and the images with a single application and single set of actions, or the medical facility may send the images using one application that sends one transmission and send the orders using a different application that sends a separate transmission.

In some implementations, the network 208 may be a secure network, such as a virtual private network (VPN). The VPN may include a secure computing device or terminal at the medical facility 204, at the IO management system 202, and at the client device 206. Encrypted transmissions (e.g., of image and order data) sent through the network 208 between the medical facility 204, the IO management system 202, and the client device 206 may also include the use of other forms of secure communications, such as the Secure Socket Layer (SSL), Terminal Services, and Citrix systems.

In the IO management system 202 there may be an access control module 222 that controls user access to the IO management system 202. Users may include staff at a hospital, imaging center, medical research facility or other medical facility and radiologists at the client devices 206. For example, the access module 222 may include a remote desktop application, such as Terminal Services, that allows users to login to the management system 202. As another example, the access control module 222 may include an application portal accessible from the remote desktop or from the Internet with individual logins and passwords for each user. If the access control module 222 grants access to a user at the medical facility 204A, the user may be able to send images and orders or receive reports, as indicated by arrows 224 and 226, respectively. If an order is assigned to and accepted by a radiologist at the client device 206A, the radiologist may be able to retrieve the order and its images or send a report. The access control module 222 may also monitor the connectivity status of the medical facilities 204 or the client devices 206. For example, control module 222 may monitor whether a secure network connection between the medical facilities 204 or the client devices 206 and the I/O management system 202 is operational.

When image data is received by the IO management system 202 and accepted by the access control module 222 it may be sent to a production module 230. The production module 230 may handle real-time processing in the IO management system 202, such as managing the workflow of orders and images. The production module 230 may forward the image data to an image server 232, as indicated by arrows 234 and 236, for processing and storage. For example, the image server 232 may be part of a Picture Archive Communication System (PACS), which may digitally store, process, transmit, and facilitate the display of radiology images.

In some implementations, the production module 230 and the image server 232 may not communicate in the same format, so a messaging module 248 may handle communications between the two. For example, if the production module 230 is able to read text files as input, the messaging module 248 may take output from another source, such as the image server 232, and convert it into a text file format that the production module 230 can interpret.

When an order is received by the IO management system 202 and accepted by the access control module 222 it may be sent to the production module 230. The production module 230 may forward the order to an order module 250, such as a Radiology Information System (RIS), as represented by arrows 234 and 252, for processing. The messaging module 248 may process communication between the production module 230 and the order module 250.

Once the IO management system 202 receives an order, the production module 230 may assign the order to a user of a client device 206. The production module 230 may also assign the order to several users at several client devices 206. If the access control module 222 grants a user of a client device access, the user may retrieve orders from the order module 250 and image data from the image server 232, as indicated by arrows 254, 256, and 258.

The IO management system 202 may include a data module 160 that stores data associated with the system 202. For example, order data used by the order module 250 and image data used by the image server 232 may be stored by the data module 160. In some implementations, image data may be stored by the image server 232.

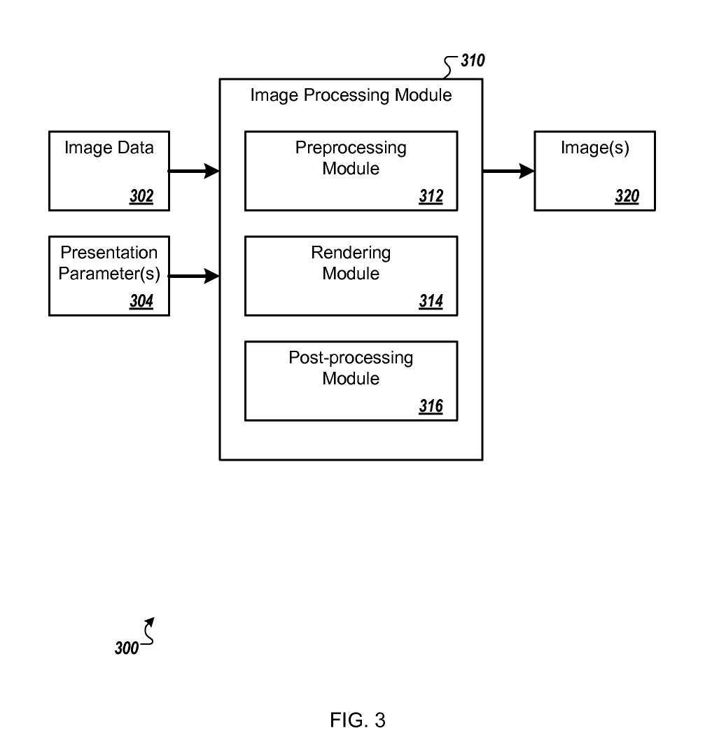

FIG. 3 is a block diagram of an example process 300 for generating one or more images for presentation. The process 300 may be performed by a single system or server, or across multiple systems or servers. In some implementations, the process 300 may be performed by the image server 232 (shown in FIG. 2). In some implementations, the process 300 may be performed by the imaging system 102, and/or the IO management system 104, and/or the image review system 106 (shown in FIG. 1).

Inputs to the process 300 include image data 302 and one or more presentation parameters 304. For example, the image data 302 can be captured and provided by the imaging system 102 (shown in FIG. 1). The presentation parameters 304, for example, can be provided by the image review system 106 (shown in FIG. 1). For example, the user 132 (e.g., a radiologist) of the image review system 106 can specify one or more of the parameters through a graphical user interface. In some implementations, one or more of the presentation parameters 304 may include default values.

The process 300 may perform a variety of functions for generating images and for preparing images for transmission or presentation. In some implementations, the functions may be coordinated by an image processing module 310. The image processing module 310, for example, may include a preprocessing module 312, a rendering module 314, and a post-processing module 316.

The preprocessing module 312 may perform operations such as modifying image formats or extracting image information. For example, the preprocessing module 312 may use computed tomography (CT) to generate a three-dimensional model from the image data 302 (e.g., a series of two-dimensional images). As another example, the preprocessing module 312 may extract metadata (e.g., patient information, medical facility information) from or add metadata to one or more image data files.

The rendering module 314 may perform operations such as generating images for presentation based on the image data 302 and based on the presentation parameter(s) 304 (e.g., zooming, panning, rotating, contrast, color, view angle, view depth, rendering or reconstruction technique, and the like). For example, based on the presentation parameter(s) 304, a three-dimensional model or a series of two-dimensional images can be manipulated and reformatted for generating one or more images 320.

The post-processing module 316 may perform operations such as preparing the images 320 for transfer or display (e.g., at the image review system 106). For example, the post-processing module 316 may use a lossless compression technique to prepare the images 320. As another example, metadata may be added to or extracted from image files by the post-processing module 316.

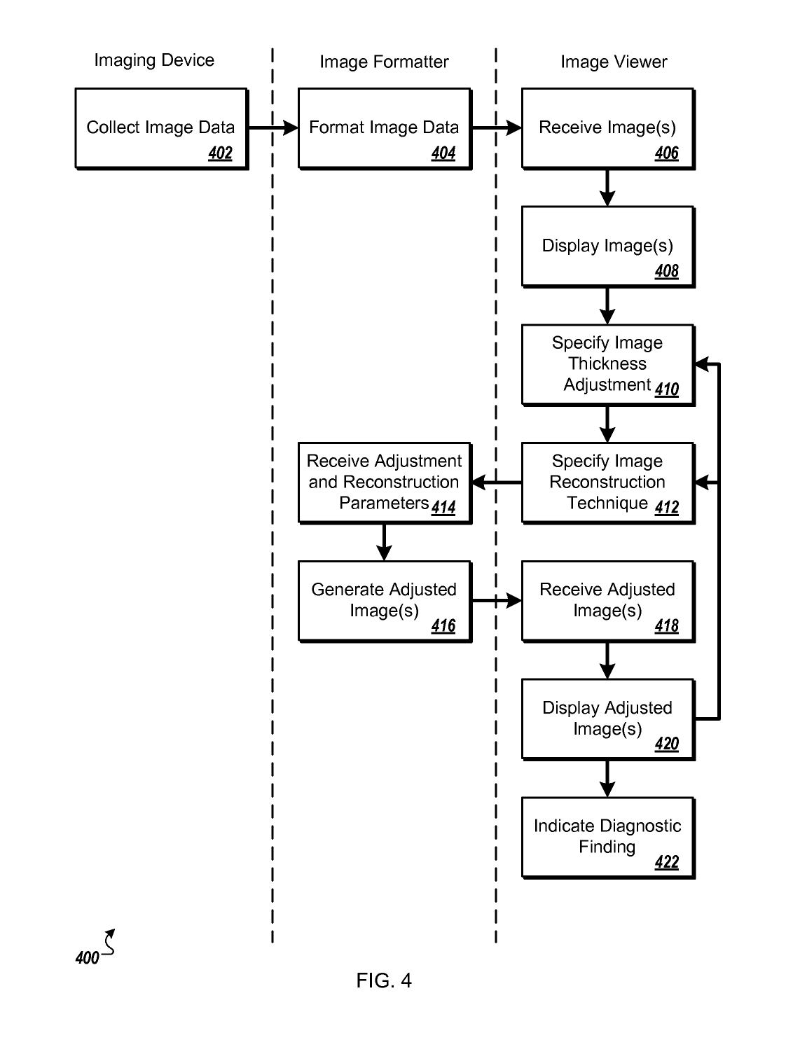

FIG. 4 is a flow chart showing an example process 400 for displaying and adjusting images. In some implementations, the process 400 may be performed by the system 200 (as shown in FIG. 2). In some implementations, the process 400 may be performed by the system 100 (as shown in FIG. 1) and will be described as such for clarity. A particular order and number of steps are described for the process 400. However, it will be appreciated that the number, order, and type of steps required for the process 400 may be different in other examples.

In step 402, an imaging device (e.g., the imaging device 110) may collect image data. For example, collected image data can include a series of radiological images of the subject 112 taken from a single axis of rotation.

In step 404, an image formatter may format the image data. For example, functions of the image formatter may be performed by one or more computers or systems executing the image processing module 310 (shown in FIG. 3), such as the imaging system 102, and/or the IO management system 104, and/or the image review system 106. The image formatter may, for example, use the image data to produce a three-dimensional model of the subject 112. The three-dimensional model may be manipulated and reformatted for generating various model views, for example, based on one or more presentation parameters.

In step 406, an image viewer (e.g., the image review system 106) may receive one or more images, and in step 408, the image viewer may display the images. For example, the image review system 106 may display the images to the user 132 (e.g., a radiologist) at the display device 136. The user 132, for example, may elect to view each image in a series of radiological images (e.g., by scrolling through) or may elect to adjust the images. For example, the user 132 may interact with a graphical user interface using any of the input devices 138A-B to indicate a change to one or more presentation parameters for adjusting the images.

In step 410, for example, the user 132 may specify an image thickness adjustment. For example, the user 132 may elect not to view each individual image in an image series, but instead to view a composite of a set of images over a particular depth or thickness. By adjusting the image depth or thickness, for example, the user 132 may modify the number of images for combined viewing. For example, an increased image thickness may decrease the number of images, and a decreased image thickness may increase the number of images.

In step 412 the user 132, for example, may specify an image reconstruction technique. For example, the user 132 may specify various projection methods, such as maximum-intensity projection (MIP), minimum-intensity projection (mIP), or color averaging. For example, MIP reconstructions may enhance areas of high radiodensity, and mIP reconstructions may enhance air spaces. Averaging reconstructions, for example, may be used to form a composite of a set of images in a series.

In step 414, for example, the image formatter may receive the image adjustment and reconstruction parameters, and in step 416, the image formatter may generate one or more adjusted images. For example, using a slabbing operation, the image formatter can perform an averaging of a set of images that are contiguous in an image space. The averaging, for example, can be based on parameters such as the indicated image thickness and the indicated reconstruction technique. In some implementations, the averaging can include calculating average pixel color values for multiple images in a set, to create a single composite image. In some implementations, the images may be generated dynamically. For example, the image formatter can adjust images based on one or more provided parameters as the user 132 scrolls through an image series.

In step 418, for example, the image viewer may receive one or more adjusted images, and in step 420, the image viewer may display the images. The user 132 may view and interact with the displayed images, and may indicate further image adjustments. For example, the user may specify a further image thickness adjustment (step 410) and/or another image reconstruction technique (step 418). The user 132 may also indicate a diagnostic finding (step 422).

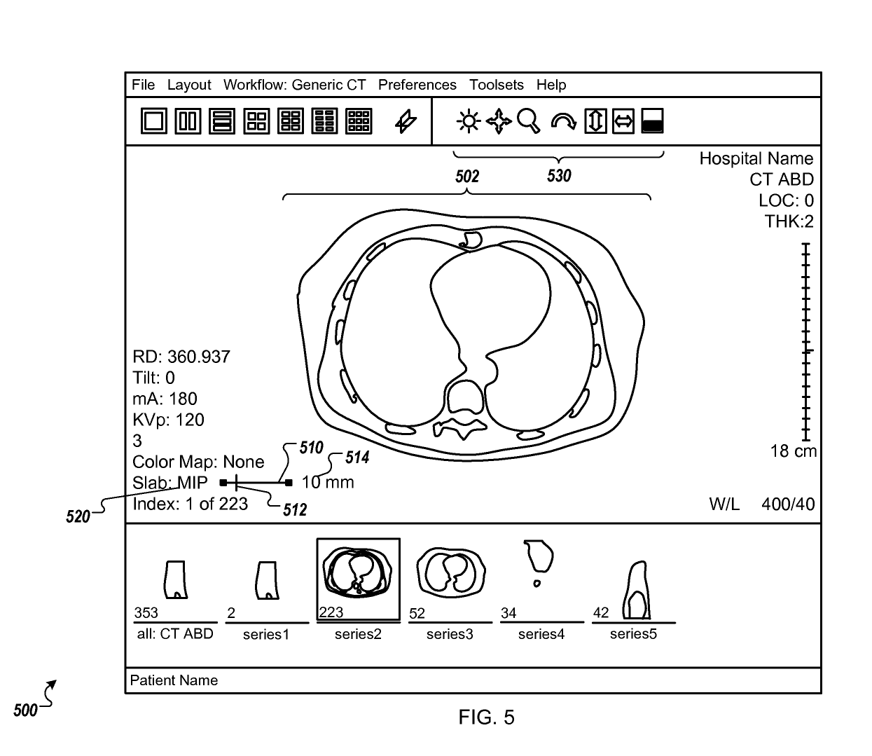

FIG. 5 is an illustration of an example interface 500 for presenting and adjusting radiological images. In some implementations, the interface 500 may be displayed at the image display device 136 by the image review system 136 (as shown in FIG. 1) and will be described as such for clarity. For example, the user 132 may use any of the input devices 138A-B to interact with one or more user controls included in the interface 500 to specify image adjustments (e.g., zooming, panning, rotating, contrast, color, view angle, view depth, rendering or reconstruction technique, and the like). Based on the specified adjustments, for example, the teleradiology system 100 may generate one or more adjusted radiological images based on information received from the controls, and may present the adjusted image(s) at the image display device 136.

In some implementations, the interface 500 may include a control 510 for specifying a slab thickness of the radiological image 502. For example, the user 132 may adjust slab thickness by clicking a hash mark 512 included in the control 510, then sliding the hash mark 512 to the left to reduce thickness, or sliding it to the right to increase thickness. As another example, the user 132 may adjust slab thickness by double-clicking a current thickness value 514 and entering a desired value. In some implementations, the control 510 and value 514 may indicate an image thickness in terms of distance. In some implementations, the control 510 and value 514 may indicate an image thickness in terms of percentage (e.g., a percentage increase or decrease in thickness, or a percentage relative to overall image space). In some implementations, the control 510 and value 514 may indicate a number of images to combine.

In some implementations, the interface 500 may include a control 520 for specifying a reconstruction technique. For example, the user 132 may specify a reconstruction technique by clicking the control 520 to activate a dropdown menu. From the dropdown menu, for example, the user 132 may select a reconstruction technique, such as maximum-intensity projection (MIP), minimum-intensity projection (mIP), or color averaging.

In some implementation, the interface 500 may include one or more additional controls 530 for specifying additional image adjustments, such as zooming, panning, rotating, contrast, color, view angle, and the like. The controls 530, for example, may also be used by the user 132 for adjusting radiological images.

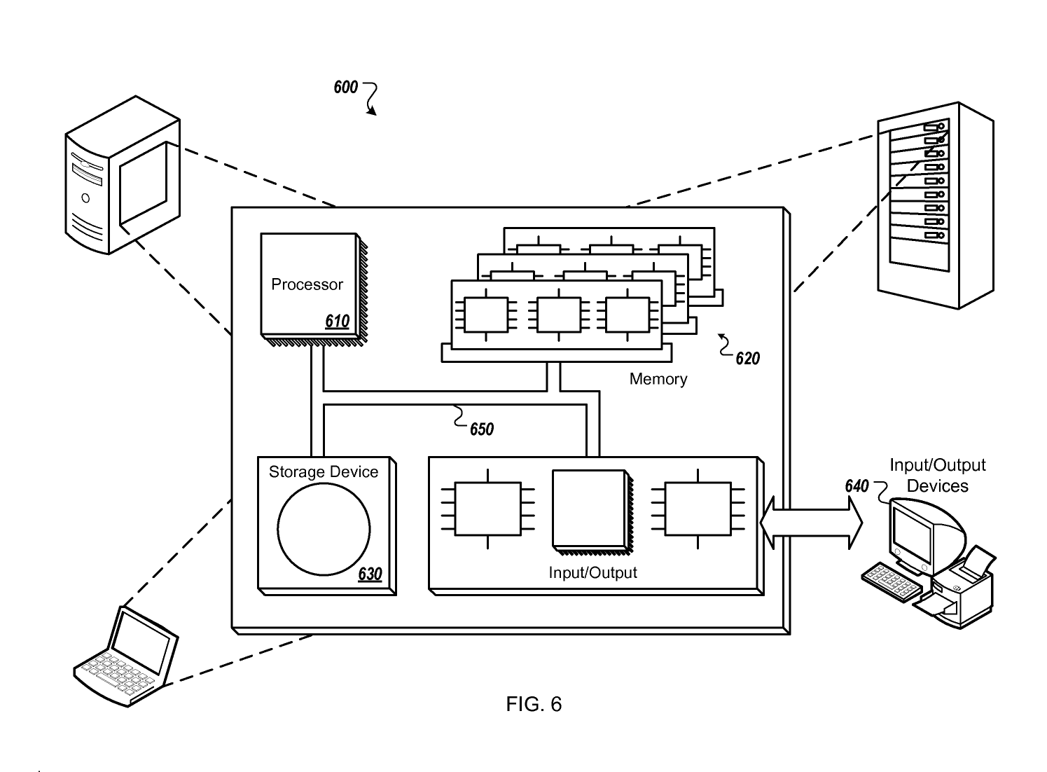

FIG. 6 is a schematic diagram of a generic computer system 600. The system 600 can be used for the operations described in association with any of the computer-implement methods described previously, according to some implementations. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. The memory 620 is a volatile memory unit in some implementations and is a non-volatile memory unit in other implementations.

The storage device 630 is capable of providing mass storage for the system 600. In some implementations, the storage device 630 is a computer-readable medium. In some implementations, the storage device 630 may be a floppy disk device, a hard disk device, an optical disk device, or a tape device.

The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of this disclosure. Accordingly, other implementations are within the scope of the following claims.

What is claimed is:

1. A computer-implemented method for adjusting a radiological image, the method comprising:
displaying a radiological image to a user;
receiving first input via a first user interface control indicating a specified adjustment to be made in slab thickness of the radiological image;
receiving second input via a second user interface control indicating a specified reconstruction technique to be applied to the radiological image; and
displaying an adjusted radiological image generated using the specified adjustment of the slab thickness and the specified reconstruction technique.

2. The computer-implemented method of claim 1, wherein the specified adjustment in slab thickness includes increasing or decreasing the slab thickness by a user-specified distance.

3. The computer-implemented method of claim 1, wherein the specified adjustment in slab thickness includes increasing or decreasing the slab thickness by a user-specified percentage.

4. The computer-implemented method of claim 1, wherein the specified adjustment in slab thickness includes a user-specified number of images being combined into the adjusted radiological image.

5. The computer-implemented method of claim 1, wherein the specified reconstruction technique includes maximum-intensity projection.

6. The computer-implemented method of claim 1, wherein the specified reconstruction technique includes minimum-intensity projection.

7. The computer-implemented method of claim 1, wherein the specified reconstruction technique includes color averaging.

8. The computer-implemented method of claim 1, wherein the adjusted radiological image is generated dynamically while the radiological image is displayed.

9. A system for adjusting a radiological image, the system comprising:
an imaging device for capturing image data;
an image formatter for rendering a radiological image based on captured image data and based on one or more presentation parameters;
an image viewer for receiving and displaying the radiological image; and
one or more input devices for receiving a specified adjustment in slab thickness of the radiological image and a reconstruction technique for the radiological image.

10. The system of claim 9, wherein the specified adjustment in slab thickness includes increasing or decreasing the slab thickness by a user-specified distance.

11. The system of claim 9, wherein the specified adjustment in slab thickness includes increasing or decreasing the slab thickness by a user-specified percentage.

12. The system of claim 9, wherein the specified adjustment in slab thickness includes a user-specified number of images being combined into the adjusted radiological image.

13. The system of claim 9, wherein the reconstruction technique includes maximum-intensity projection.

14. The system of claim 9, wherein the reconstruction technique includes minimum-intensity projection.

15. The system of claim 9, wherein the reconstruction technique includes color averaging.

16. A computer program product tangibly embodied in a computer-readable storage medium, the computer program product including instructions that, when executed, generate on a display device a graphical user interface for adjusting a radiological image, the graphical user interface comprising:
a presentation area for displaying the radiological image;
a first control for receiving a specified adjustment in slab thickness of the radiological image; and
a second control for specifying a reconstruction technique to be applied to the radiological image;
wherein the presentation area displays an adjusted radiological image generated using the specified adjustment of the slab thickness and the specified reconstruction technique.

17. The computer program product of claim 16, wherein the first control includes a movable element.

18. The computer program product of claim 17, wherein the movable element is configured to be moved in one direction to specify a reduction in slab thickness, and to be moved in another direction to specify an increase in slab thickness.

19. The computer program product of claim 16, wherein the first control is configured for user entry of a value.

20. The computer program product of claim 16, wherein the second control is configured for user selection from a list of values.
